(19) United States
(12) Patent Application Publication
(10) Pub. No.: US 2010/0052631 A1
(43) Pub. Date: Mar. 4, 2010

(54) STRUCTURE OF A POWER SUPPLY

(76) Inventors: Xin WU, Shanghai (CN); Shu-Zhuang LU, Shanghai (CN)

Correspondence Address: Muncy, Geissler, Olds & Lowe, PLLC, P.O. BOX 1364, FAIRFAX, VA, 22038-1364, US

(21) Appl. No.: 12/200,225

(22) Filed: Aug. 28, 2008

(51) Int. Cl. G05F 1/00

(52) U.S. Cl. 323/266

(57) ABSTRACT

An improved structure of a power supply mainly discloses three PSR solutions based on a PWM controller that is used in charger/adapter solutions, in which a low voltage PNP transistor and zener diode composes error signal amplification circuit, or −431 typed shunt regulators senses and amplifies the input error signal caused by the changes of load or line voltage, or one diode and two resistors form sense circuit of error signal. These PSR solutions employ a transformer, in which the input side of the transformer is connected to an AC input and PWM controller, and the output side of the transformer is connected to a rectified diode. The present invention further provides low cost PSR solutions with higher system reliability, better line/load regulation, and short circuit characteristic.

### FIELD OF THE INVENTION

The present invention is related to low power charger/adapter solutions with primary side regulation that bases on emitter/source switched PWM controller.

### BACKGROUND OF THE INVENTION

Most chargers/adapters adopt switching mode power supply (SMPS) in mobile phone and home appliance to replace linear transformer solution. The SMPS circuit usually consists of AC input, PWM controller, transformer and constant voltage/current control circuit, wherein the constant voltage/current control circuit are coupled through an optical coupling element, and the input side of the transformer is connected to the AC input and PWM controller of the charger/adapter, and the output side of the transformer is connected to the constant voltage/current control circuit and optical coupling element. All these SMPS circuits employ step-down transformer composed of primary side winding, secondary side windings and/or bias winding.

FIG. 1 is a circuit diagram which shows a kind of charger/adapter circuit in the prior architecture.

It shows a kind of common charger/adapter circuit 100. The charger/adapter circuit 100 includes an AC input section 101 and PWM controller 102, transformer 103, constant voltage control circuit 108, and constant current control circuit 109, wherein the constant voltage control circuit 108 and the constant current control circuit 109 are coupled with the AC input section 101 and PWM controller 102 through an optical coupling element 104. In the charger/adapter circuit 100, the input side of the transformer 103 has primary winding 103a and an input bias winding 103b, and the output side has an output winding 103c, wherein the first terminal of the output winding 103c is connected to the positive electrode of the diode 118, and its second terminal is connected to the current sense resistor 113. In the charger/adapter circuit 100, resistors 114 and 115 are for regulating the output voltage to achieve constant voltage, capacitor 110 are voltage compensative element, capacitor 111 are current compensative element, resistor 113 is to achieve constant current, and other accessorial electronic elements includes capacitor 117 & 119, resistor 120 & 122. It must be pointed that constant current circuit 109 and all these accessorial elements are changeable and optional.

Compared to linear transformer circuit, the charger/adapter circuit 100 employs PWM and constant voltage/current controller 102, 103, 109 to precisely adjust duty cycle when line voltage or load is changed, so system reliability, output characteristics, line and load regulation are all better than linear transformer circuit. However, the cost of SMPS circuit is about 20%˜50% higher than linear transformer circuit, so many charger/adapter makers can not satisfied with the SMPS circuit.

Therefore, it is absolutely necessary to provide new cost down solutions with less component count, small print circuit board size and better price/performance ratio.

### SUMMARY OF THE INVENTION

The present invention is to provide basic cost down solutions with primary side regulation (PSR solution) for low power charger/adapter application with higher system reliability, better line/load regulation, and short circuit characteristic.

The invention is based on a low cost PWM controller with emitter switched architecture. The current mode PWM controller contains output terminal, the VCC terminal and ground terminal. The output terminal is to produce switching pulse which can be connected with the emitter of NPN transistor or the source of MOSFET, the VCC terminal is used for both bias supply and feedback control, the ground terminal is supply ground.

The present invention provides low voltage PNP transistor and zener diode to improve the line and load regulation.

The present invention provides −431 typed shunt regulators to further improve the line and load regulation.

The present invention also provides one diode and two resistors to form sense circuit of error signal.

The present invention provides a transformer used in the charger/adapter solution, in which the input side of the transformer is connected to an AC input and PWM control circuit, the output side of the transformer is connected to rectified diode, no need of constant current/voltage circuit, no need of an optical coupling element, so the cost of the PSR solution is lower than linear transformer solution, and it can be called low cost PSR solution.

The present invention of PSR solutions has such features as less component number, low total cost, high reliability, and better line/load regulation, so this PSR solution will be accepted by more and more charger/adapter makers.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a circuit diagram showing a kind of charger/adapter circuit in the prior architecture.

FIG. 2 is the function block of the PWM controller

FIG. 3 is the first PSR solution based on the PWM controller

FIG. 4 is the testing result of output characteristics of the first PSR solution

FIG. 5 is the curve of output voltage VS line voltage of the first PSR solution

FIG. 6 is the second PSR solution based on the PWM controller

FIG. 7 is the third PSR solution based on the PWM controller

FIG. 8, the solution with the integrated transistor and PWM controller

FIG. 9 is the solution with the MOSFET and PWM controller

FIG. 10 is the transformer architecture to reduce EMI

### DESCRIPTION OF THE PREFERRED EMBODIMENT

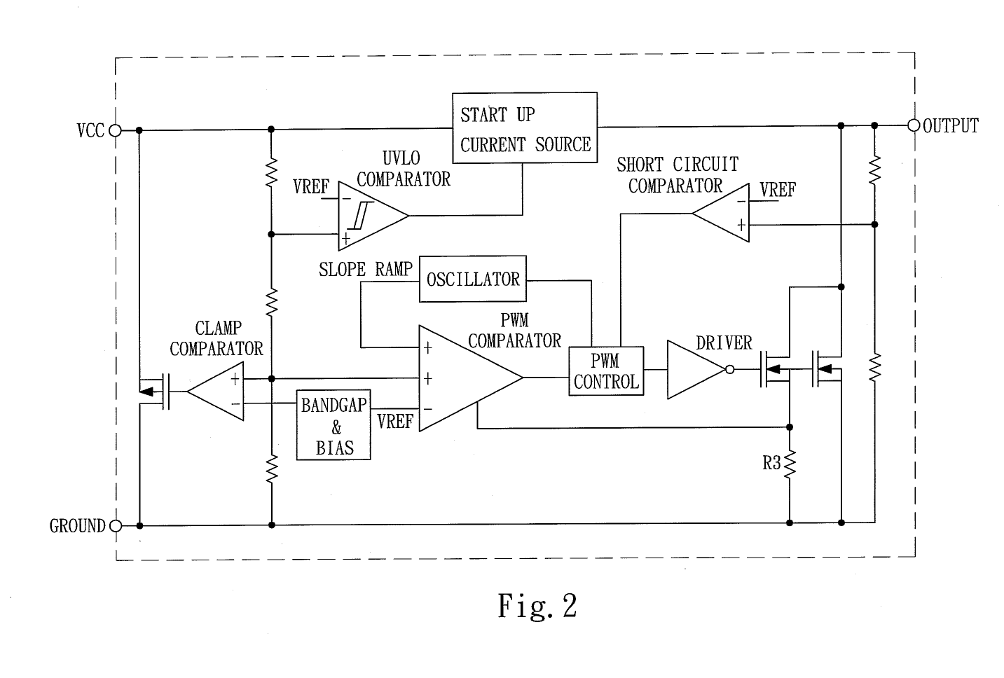

FIG. 2 is the function block of the mentioned PWM controller. Its main function circuits include: under voltage lockout with low startup current; precise voltage reference for internal comparators; PWM comparator with current limit control, feedback signal and bandgap input; short circuit comparator.

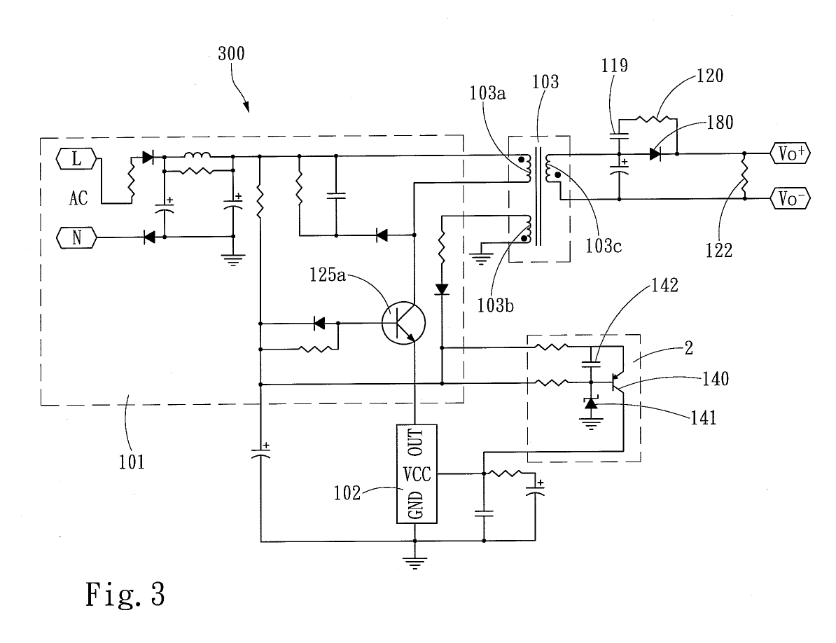

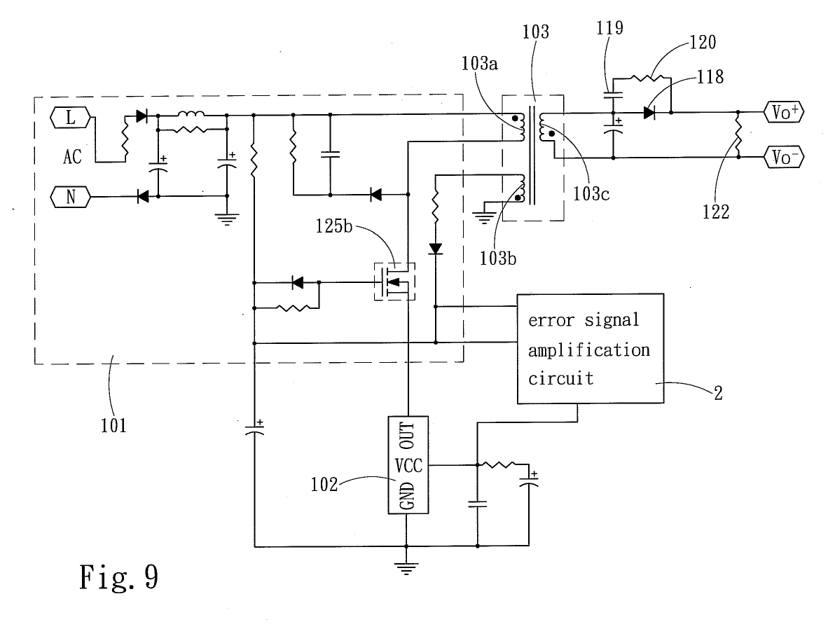

The current mode PWM controller contains output terminal, the VCC terminal and ground terminal. The output terminal is to produce switching pulse which can be connected with the emitter of NPN transistor 125a (as shown in FIG. 3) or the source of MOSFET 125b (as shown in FIG. 9), the VCC terminal is used for both bias supply and feedback control, the ground terminal is supply ground., When the PWM controller is powered on, the startup current source (or called regulators) turns on and can not turns off until VCC level rises up to its threshold value and PWM pulse is produced. The external inductor current through the output terminal is converted to a voltage by an internal resistor R3, and this voltage will participate to control duty cycle and peak inductor current.

FIG. 3 is application schematics of the first PSR solution circuit in a preferred embodiment according to the present invention. It should be noticed that, although FIG. 3 shows the practical application of the charger/adapter solution, the transformer and the charger/adapter solution are simultaneously explained in the description of FIG. 3.

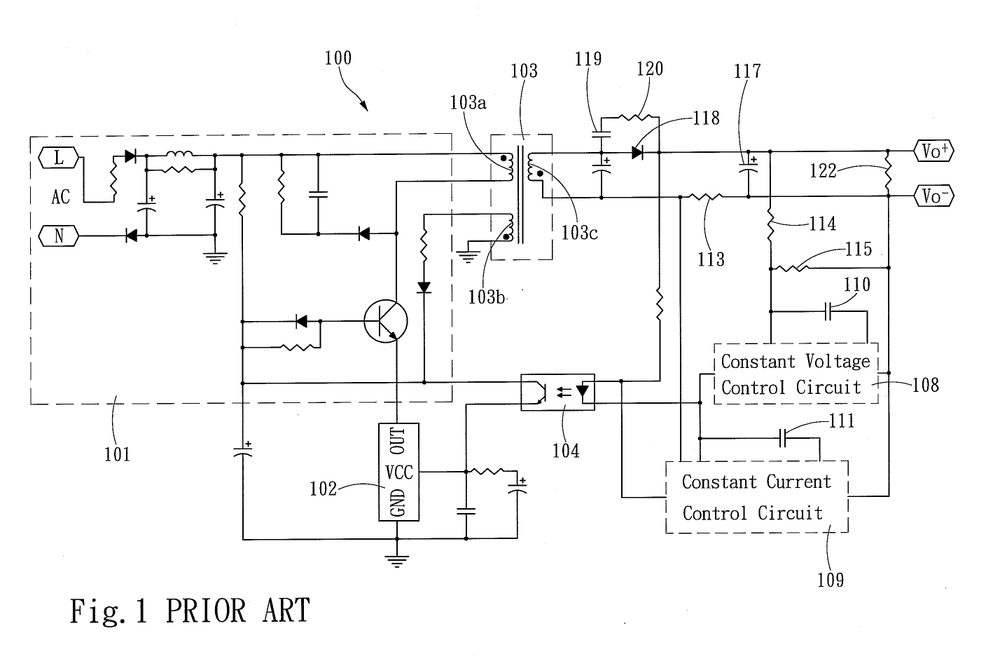

Please refer to FIG. 3, comparing FIG. 3 with FIG. 1, the circuit 300 adopts an error signal amplification circuit 2 to substitute the constant voltage control circuit 108 and/or the constant current control circuit 109. Therefore, it is no need of constant voltage/constant current circuit, optical coupling element or several accessorial elements any more. In the error signal amplification circuit 2, zener diode 141 and capacitor 142 form error signal, low voltage transistor 140 will amplify the error signal, so the PWM controller 102 can response load/line variation better to improve line/load regulation. The transformer 103 is also a key component that will influence short circuit characteristics, load and line regulation. The tight coupling between windings 103b and 103c is also important.

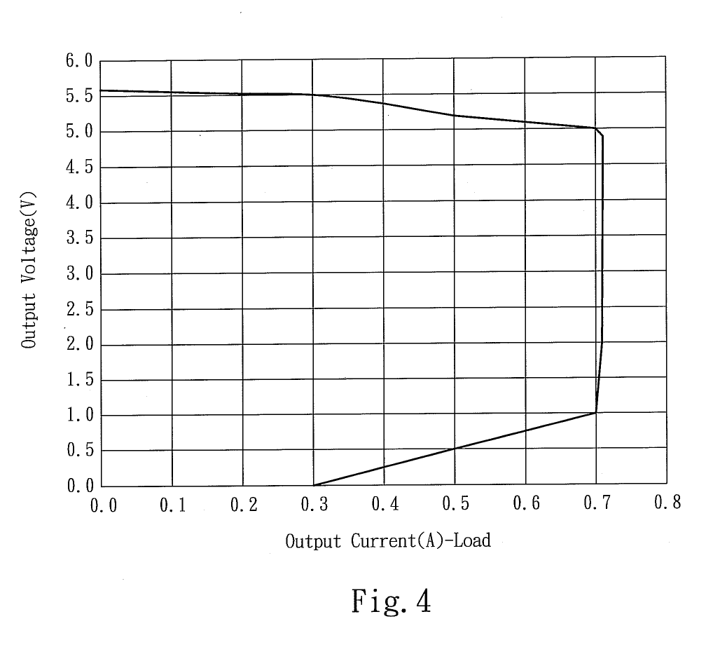

Generally, the first PSR solution for charger/adapter application according to the present invention can meet the requirement of low cost, significantly improve output characteristics, line and load regulation. The test result shows that ±15% load regulation and ±2% line regulation is obtainable in an application of 5.2V/0.7 A adapter/charger. FIG. 4 is the output characteristics under 110V AC input, and it can be seen that the variation of the output voltage is 0.53V when the output current is from 0.7 A to 0 A, so the load regulation is ±5%.

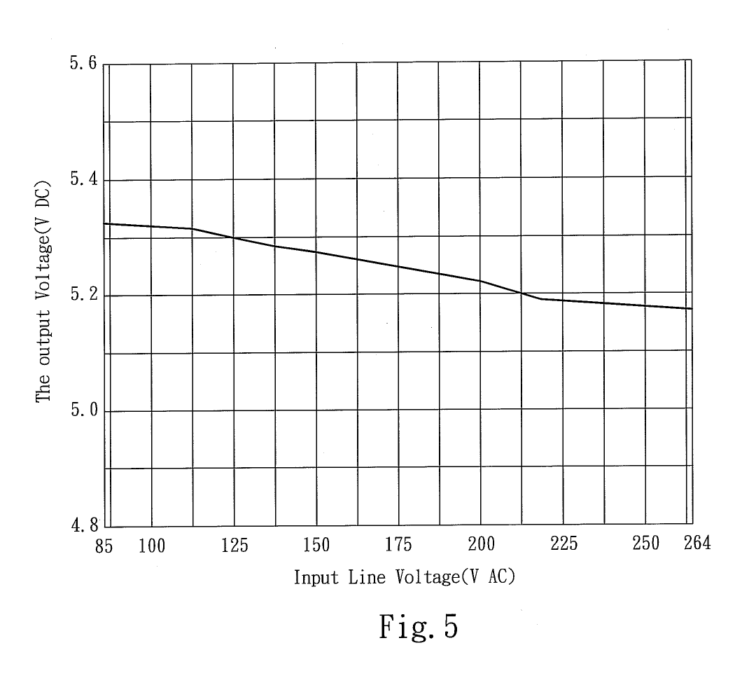

FIG. 5 gives the variation of the output voltage vs. input line voltage. When line voltage is from 85V AC to 264V AC, the output voltage is from 5.338V to 5.164V DC, so line regulation is ±1.5%.

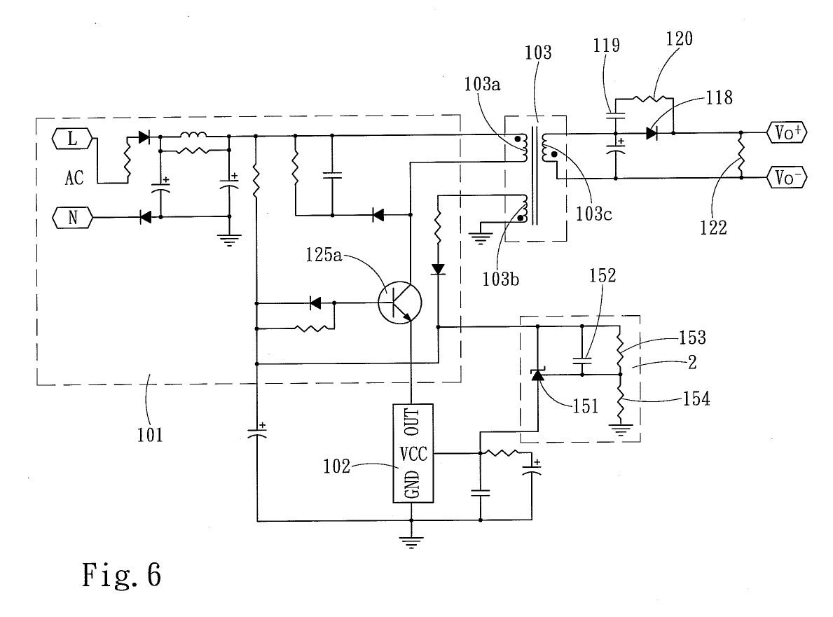

FIG. 6 is the second PSR solution for charger/adapter circuit, the error signal amplification circuit 2 is composed of −431 typed shunt regulators 151, resistor 153/154 to regulate the output voltage, and phase/gain compensation capacitor 152. Shunt regulators 151 can sense and amplify the input error signal caused by the changes of load or line voltage, so the precision of line/load regulation is good as the first PSR solution.

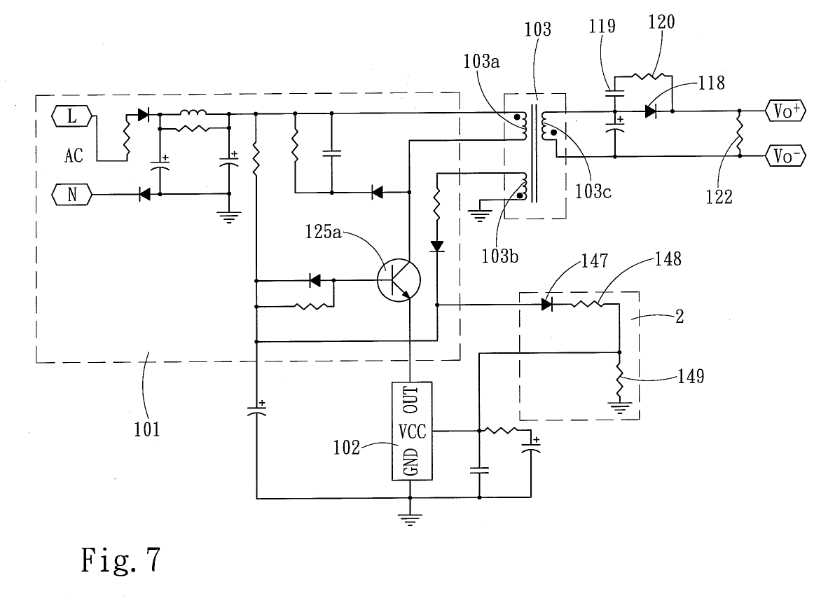

FIG. 7 is the third PSR solution for charger/adapter application, error signal amplification circuit 2, diode 147 and resistor 148/149 form sense circuit of error signal, but there is no signal amplification circuit, so the precision of line/load regulation is not as good as the first PSR solution.

The second and third PSR solutions adopt the same transformer process as the first PSR solution.

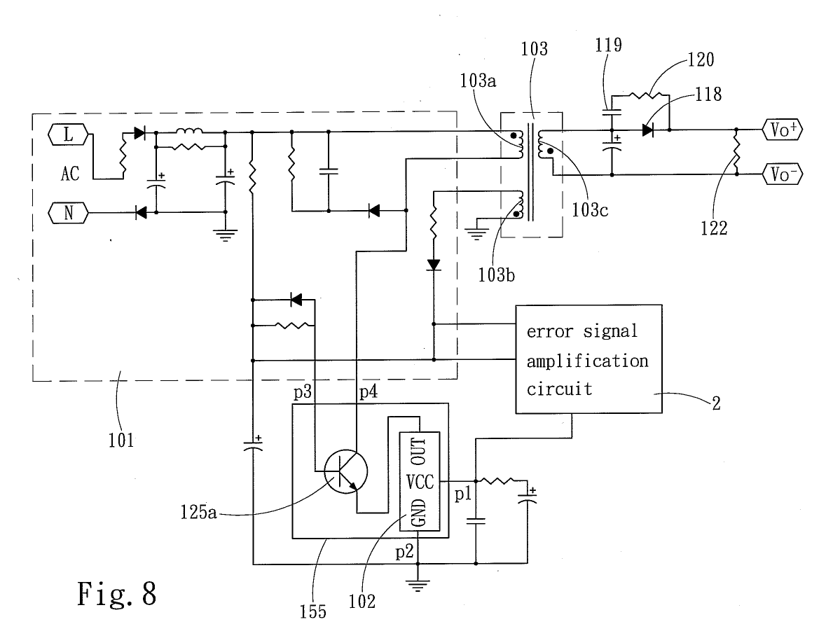

FIG. 8 is the solution with the integrated transistor and PWM controller, the integrated circuit 155 has four terminals p1, p2, p3 and p4.

FIG. 9 is the solution with the MOSFET 125b and PWM controller, the shortage of the solution is higher cost of MOSFET.

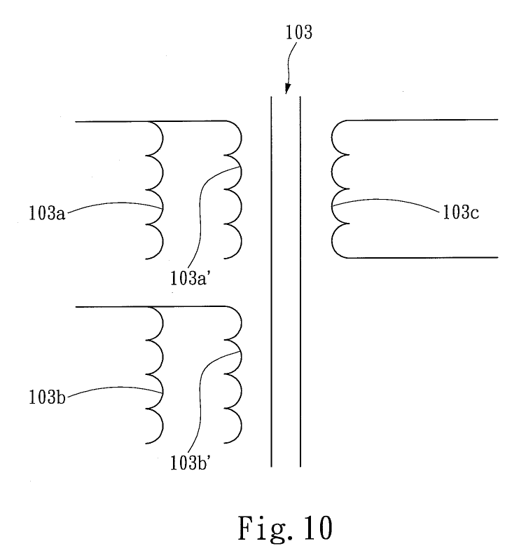

FIG. 10 is the actual transformer of the invention to replace transformer 103. Winding 103a′ is shield winding reeled with primary winding 103a. Winding 103b′ is shield winding reeled with bias winding 103b. These two shield windings can reduce EMI.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An improved structure of a power supply applied to a switching mode power supply, the switching mode power supply comprising:
an AC input section;
a PWM controller; and
a transformer and constant voltage/current circuit,
wherein an error signal amplification circuit is connected to the AC input section and the PWM controller and the error signal amplification circuit forms an error signal so that the PWM controller can response load/line variation better to improve load/line regulation.

2. The improved structure of a power supply as claimed in claim 1,
wherein the error signal amplification circuit is composed of a low voltage PNP transistor and zener diode.

3. The improved structure of a power supply as claimed in claim 1,
wherein the error signal amplification circuit is composed of shunt regulators to sense and amplify the input error signal caused by the changes of load or line voltage.

4. The improved structure of a power supply as claimed in claim 1,
wherein the error signal amplification circuit is composed of a diode and two resistors to form sense circuit of error signal.
